(19) United States
(12) Patent Application Publication
(10) Pub. No.: US 2004/0193613 A1
(43) Pub. Date: Sep. 30, 2004

(54) Method and system of context scanning

(75) Inventor: Richard M. Armand, Danvers, MA (US)

Correspondence Address: DOWNS RACHLIN MARTIN PLLC, 199 MAIN STREET, P O BOX 190, BURLINGTON, VT, 05402-0190, US

(73) Assignee: IDX Investment Corporation, South Burlington, VT (US)

(21) Appl. No.: 10/392,573

(22) Filed: Mar. 20, 2003

(51) Int. Cl. G06F 7/00

(52) U.S. Cl. 707/100

(57) ABSTRACT

A method and system for automatically indexing electronic image files generated by a scanner (38) and scanner control application (24) with records in a computerized record keeping system application (22) having an association module (23). The method includes designating a presently selected record (62) by selecting a specific record within computerized record keeping system application (22), generating an electronic image file (60) of a document by scanning the document using scanner (38) controlled by scanner control application (24), and automatically associating electronic image file (60) with presently selected record (62) using an automated routine stored in association module (23). A system for automatically sharing data between scanner control application (24) used for controlling scanner (38) during the generation of electronic image files (60) and computerized record keeping system application (22) used for creating and maintaining records.

### FIELD OF THE INVENTION

The present invention relates generally to a method and system for associating electronic image files with data records. More particularly, the present invention is directed to a method and system for automatically associating electronic image files generated by a scanner with a selected record from a computerized record keeping system.

### BACKGROUND OF THE INVENTION

Rising healthcare costs have forced healthcare professionals to introduce measures that cut costs and maximize the overall efficiency related to the overhead of providing healthcare services. An example of such measures involves reducing staff employees. Another involves increasing the number of patients that are treated. Obviously, these two measures seem somewhat contradictory. The result is that the remaining staff is required to handle an increased workload. In order to compensate for the increased workload, staff personnel must find ways to perform their work tasks at an even higher level of efficiency.

Healthcare professionals generate an inordinate amount of paper records. Storage of patient records requires a large amount of physical space within an office or warehouse. Such storage space is expensive and drives up overall healthcare costs. As a result, the use of scanners to produce electronic images of various documents has become a routine practice in the healthcare industry and many other areas of business. In the healthcare industry in particular, electronic patient records are often augmented with electronic images of patient insurance cards, patient identification cards, credit cards, patient x-rays, etc. thereby further reducing the amount of physical storage that is required.

A scanner control application is typically used to control the operation of a scanning device. When a document is scanned, a user typically enters identifying information regarding the document into the scanner control application. Returning to the healthcare example, when a clerk is registering a patient at the front desk of a hospital or private practice and wishes to scan the patient's insurance card (or some other document related to the patient), the clerk must, at some point, enter the patient's information (name, address, etc.) and document information (document type—“ID Card”) into the scanner control application. In addition, the clerk must also enter the same information into a computerized record keeping system application such as a healthcare patient record database application prior to initiating any scanning activities. Considering the increasing demands on healthcare staff personnel to maximize their efficiency (mentioned above), this practice is wasteful and inefficient.

Currently, there are no known methods or systems that have a reliable way to allow a computerized record keeping system to automatically communicate with a scanner control application. As a result, when a user captures images via scanning, the important indexing information about the images generated must be manually entered by a clerk thereby requiring the clerk to enter the same information in two different applications.

### SUMMARY OF THE INVENTION

The present invention includes a method of automatically indexing electronic image files generated by a scanner and scanner control application with records in a computerized record keeping system application. The method includes the steps of selecting a specific record within the computerized record keeping system application, generating an electronic image file of a document by scanning the document using the scanner controlled by the scanner control application, and automatically associating the electronic image file with the selected record using an automated routine that requires no action by a user.

Another aspect of the present invention is a system for automatically sharing data between a scanner control application used for controlling a scanner during the generation of electronic image files and a computerized record keeping system application used for creating and maintaining records. The system includes a module adapted to designate a selected record by selecting a specific record within the computerized record keeping system application, a module adapted to generate an electronic image file of a document by scanning the document using the scanner controlled by the scanner control application, and an association module adapted to automatically associate the electronic image file with the selected record using an automated routine that requires no action by a user.

Yet another aspect of the present invention is a method of automatically indexing electronic image files generated by a scanner and scanner control application with records in a plurality of computerized record keeping system applications stored on a plurality of computing devices. The method includes the steps of designating a selected record by selecting a specific record within a specific computerized record keeping system application from the plurality of computerized record keeping system applications, generating an electronic image file of a document by scanning the document using the scanner controlled by the scanner control application, and automatically associating the electronic image file with the selected record using an automated routine that requires no action by a user.

Other features, utilities and advantages of various embodiments of the invention will be apparent from the following more particular description of embodiments of the invention as illustrated in the accompanying drawings.

### BRIEF DESCRIPTION OF THE DRAWINGS

For the purpose of illustrating the invention, the drawings show one or more forms of the invention. However, it should be understood that the present invention is not limited to the precise arrangements and instrumentalities shown in the drawings, wherein:

FIG. 1 is a diagram of a conventional personal computer including one embodiment of the present invention;

FIG. 2 is a diagram of the relationship between a computerized record keeping system application and a scanner control application according to one embodiment of the present invention;

FIG. 3 is a diagram of the steps of a method according to one embodiment of the present invention;

FIG. 4 is a diagram of the relationship between a selected record and an electronic image file as part of a method of associating according to one embodiment of the present invention;

FIG. 5 is a flowchart of steps for a method of associating a selected record to an electronic image file according to one embodiment of the present invention;

FIG. 6 is a diagram of the relationship between a selected record and an electronic image file as part of a method of associating according to one embodiment of the present invention;

FIG. 7 is a flowchart of steps for a method of associating a selected record to an electronic image file according to one embodiment of the present invention; and

FIG. 8 is a diagram of a network including a single scanner and three personal computers that include one embodiment of the present invention.

### DETAILED DESCRIPTION OF THE INVENTION

In the present invention method and system for context scanning, information is shared between a scanning device and scanning device control application and a computerized record keeping system application during operation of the scanning device. As a result, an electronic image created by scanning a document is automatically associated with the record that was presently selected while the document was scanned. By way of example, the present invention is described as part of a healthcare information system where the computerized record keeping system is analogous to a patient record database system. However, the present invention may also be used in other industries and professions where automated indexing of scanned images with electronic records in desired.

Turning to the drawings, wherein like reference numerals refer to like elements, the invention is illustrated as being implemented in an appropriate computing environment. Although not required, the invention will be described generally in terms of computer-executable instructions, such as program modules, being executed by a personal computer. Typically, program modules include routines, programs, objects, components, data structures, etc. that perform specific tasks. However, those skilled in the art will appreciate that the invention may be practiced with other computer system configurations, including hand-held devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

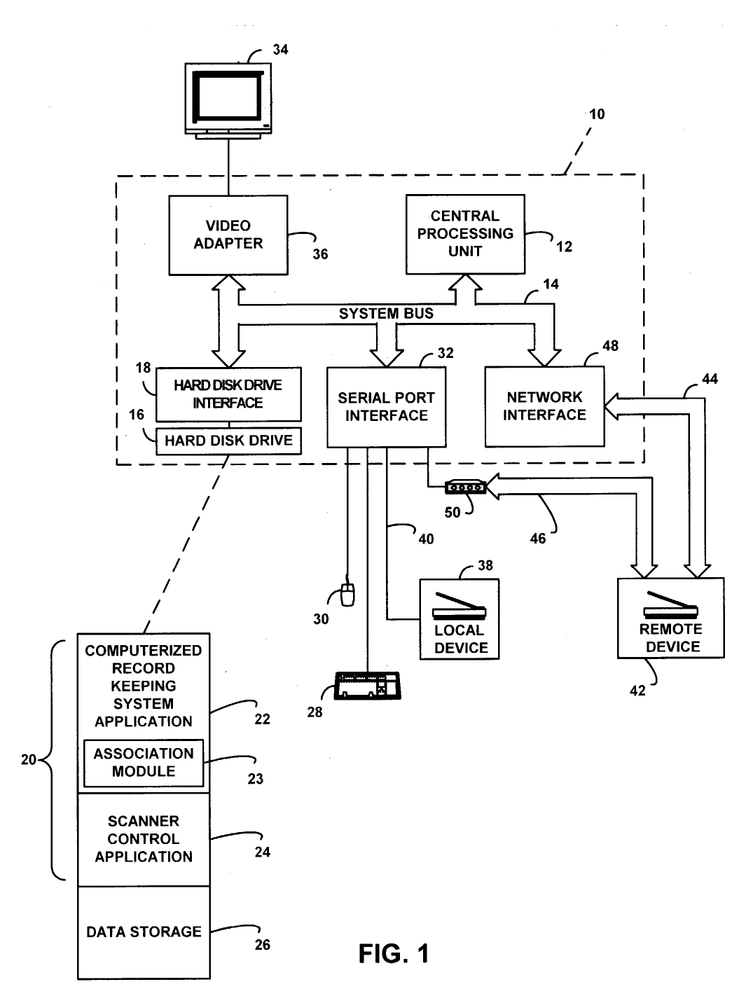

With reference to FIG. 1, one system for implementing the invention includes a general purpose computing device in the form of a conventional personal computer 10 including a processing unit 12 and a system bus 14 that couples various system components to processing unit 12. Personal computer 10 further includes a hard disk drive 16 for reading from and writing to a hard disk (not shown).

Hard disk drive 16 is connected to system bus 14 by a hard disk drive interface 18. Hard disk drive 16 provides nonvolatile storage of computer readable instructions, data structures, program modules, and other data for personal computer 10. A number of program modules 20 may be stored on hard disk 16 including computerized record keeping system application 22 having an association module 23, scanner control application 24, and program data 26. As described further below, computerized record keeping system application 22 and scanner control application 24 are utilized as part of the method and system of the present invention.

A user may enter commands and information into personal computer 10 through input devices such as a keyboard 28 and a pointing device 30. Input devices are often connected to the processing unit 12 through a serial port interface 32 that is coupled to system bus 14, but may be connected by other interfaces. A monitor 34 or other type of display device is also connected to system bus 14 via an interface, such as a video adapter 36.

In addition to being connected to a local scanner device 38 via a local, direct connection 40 through serial port interface 32, personal computer 10 may operate in a networked environment using logical connections to one or more remote devices, such as a remote scanning device 42. The logical connections depicted in FIG. 1 include a local area network (LAN) 44 and a wide area network (WAN) 46.

When used in a LAN networking environment, personal computer 10 is connected to local network 44 through a network interface or adapter 48. When used in a WAN networking environment, person computer 10 typically includes a modem 50 or other means for establishing communications over WAN 46. Modem 50, which may be internal or external, is connected to system bus 14 via serial port interface 32. In a networked environment, program modules 20 depicted relative to personal computer 10, or portions thereof, may be stored in the remote memory storage device. For example, scanner control application module 24 may be stored in remote scanner device 42.

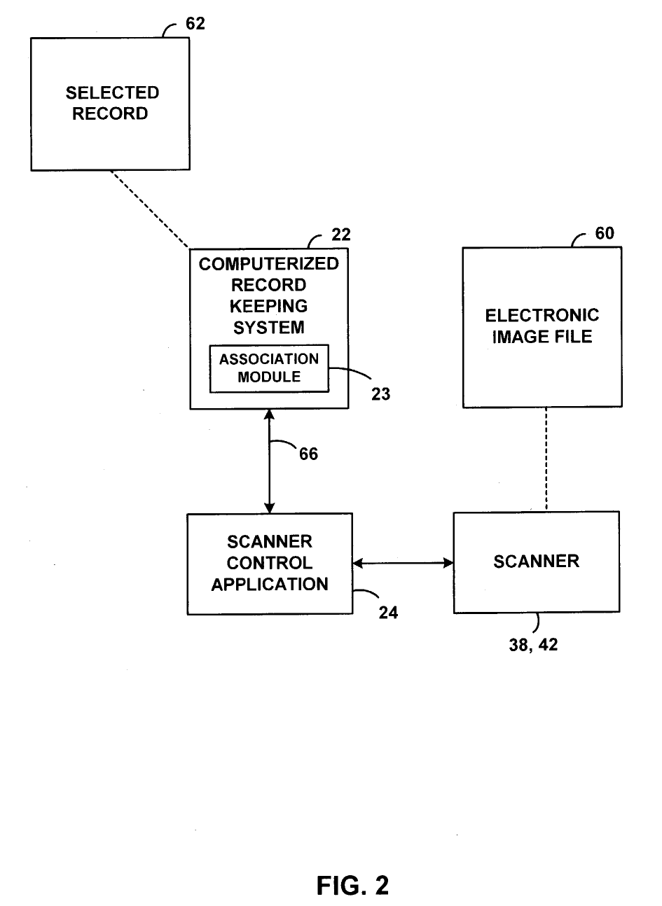

FIG. 2 provides an overview of the relationship between computerized record keeping system application 22 and scanner control application 24. As mentioned above, in the method and system of the present invention, computerized record keeping system application 22 and scanner control application 24 are in communication with one another to allow a non-associated electronic image file 60 generated by scanning device 38 to be associated with a selected record 62 within the computerized record keeping system application. As described more fully below, association module 23 may include at least two ways of creating an association between electronic image file 60 and selected record 62. First, association module 23 may capture information regarding the filename and location of electronic image file 60 and provide such information to computerized record keeping system application 22. Second, association module 23 may capture information that precisely identifies selected record 62 and provide such information to scanner control application 24. In the embodiment illustrated in FIG. 2, association module 23 is incorporated in computerized record keeping system 22. However, in other embodiments of the present invention, association module 23 may be incorporated in scanner control application 24 or be incorporated in a stand-alone application (not shown). A bi-directional arrow 66 notes the transfer of information between computerized record keeping system application 22 (and association module 23) and scanner control application 24.

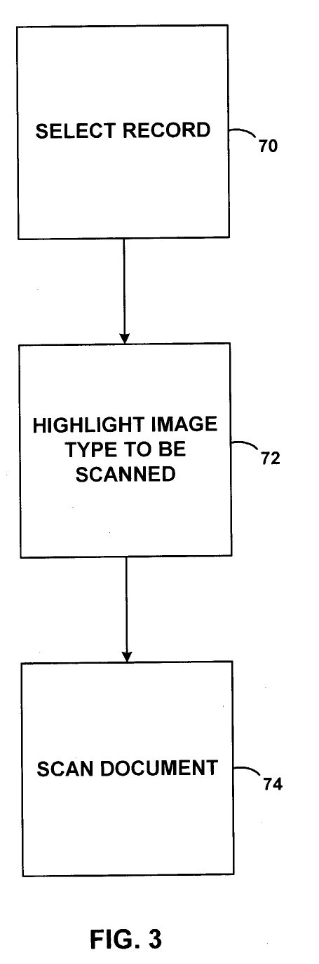

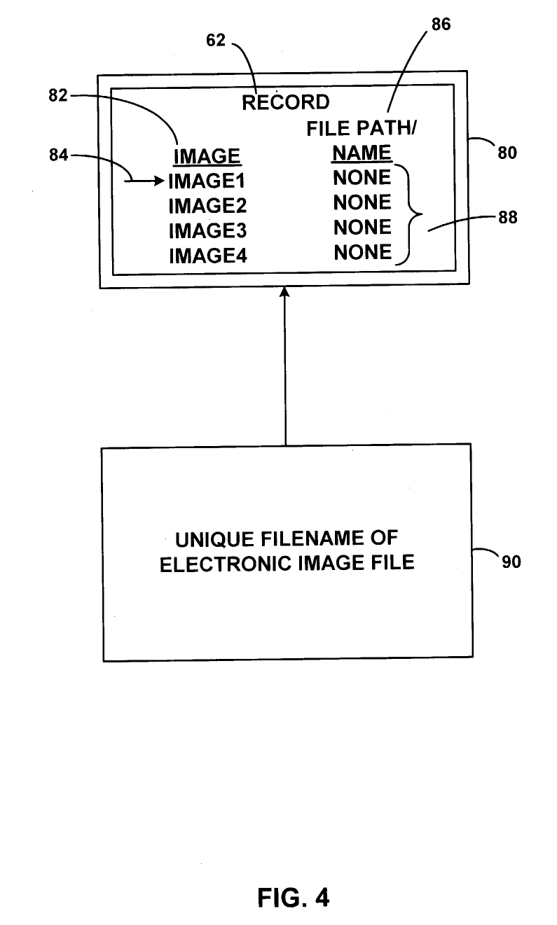

Regardless of the specific manner in which an association between selected record 62 and electronic image file 60 is created, in one embodiment of the present invention, a common routine is completed to achieve such an association. As illustrated in FIG. 3, first, at step 70, a user selects a record to view and or edit within computerized record keeping system application 22. In the case of a computerized record keeping system application used to store patient records, a user may select a specific record by entering unique information related to a specific patient. Alternatively, a user may select a recently selected record from a menu of such records. Next, at step 72, a user selects an image type to be scanned (described further with respect to FIG. 4). Finally, at step 74, a document is scanned at scanner device 38 thereby creating electronic image file 60.

With reference to FIGS. 1 and 4, computerized record keeping system application 22 includes a user interface such as a graphical user interface 80 for viewing at least a portion of selected record 62. A user views graphical user interface 80 and selected record 62 using monitor 34. Using keyboard 28 and or pointing device 30, a user selects an image from an image column 82, such as “IMAGE 1” identified by arrow 84 (FIG. 4). Also in this embodiment, a second column 86 indicates the associated electronic image file path and file name 88 for the image selected. In addition, it is contemplated that each file path/name field 88 will be a hypertext link to underlying electronic image file 60.

In FIG. 4, under image column 82, each image entry is identified by an image number, e.g., “IMAGE#”. In column 86, each file path is identified as “NONE”, which is a default value entered prior to scanning any documents. In at least one embodiment, a user will be able to select an image type from a drop-down menu when they highlight an image under image column 82. In the healthcare context, examples of image types include insurance card, license, social security card, x-rays, etc. In addition, after a document is scanned, association module 23 captures electronic image file 60 generated by scanner control application 24, a unique file name 90, and stores electronic image file 60 in a predetermined file folder located on hard disk drive 16 or elsewhere. In some embodiments, electronic image file 60 may be stored directly in a database portion of computerized record keeping system 22 according to instructions in association module 23. Association module 23 then provides the precise file name and file path with computerized record keeping system application 22 thereby populating the file path field 88 in column 86 for the corresponding image in image column 82 (as also indicated by the end of arrow 66 pointing toward computerized record keeping system application 22 in FIG. 2).

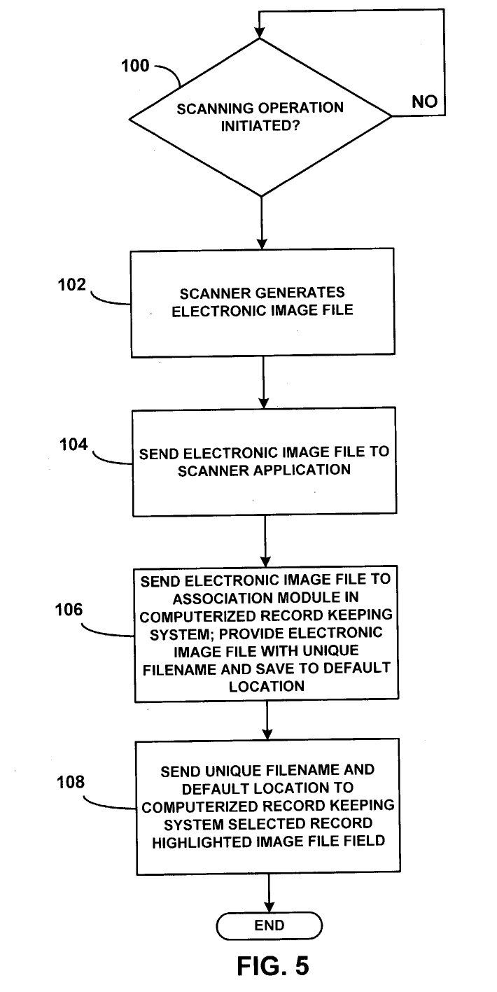

FIG. 5 illustrates a flowchart including the steps of a method according to the present invention. First, at step 100, it is determined whether or not a scanning operation has been initiated at scanner 38. If not, the method waits in stand-by until a scanning operation is initiated. After a scanning operation has been initiated, at step 102, scanner 38 generates electronic image file 60. Then, at step 104, the electronic image file 60 is sent to scanner control application 24. Scanner control application 24 sends electronic image file 64 to association module 23. Association module 23 provides electronic image file 60 with a unique filename and stores the file at a default location at step 106. Next, at step 108, association module 23 provides the filename and location of electronic image file 64 to computerized record keeping system application 22 and file path/name field 88. The method then ends until the next scanning operation is initiated.

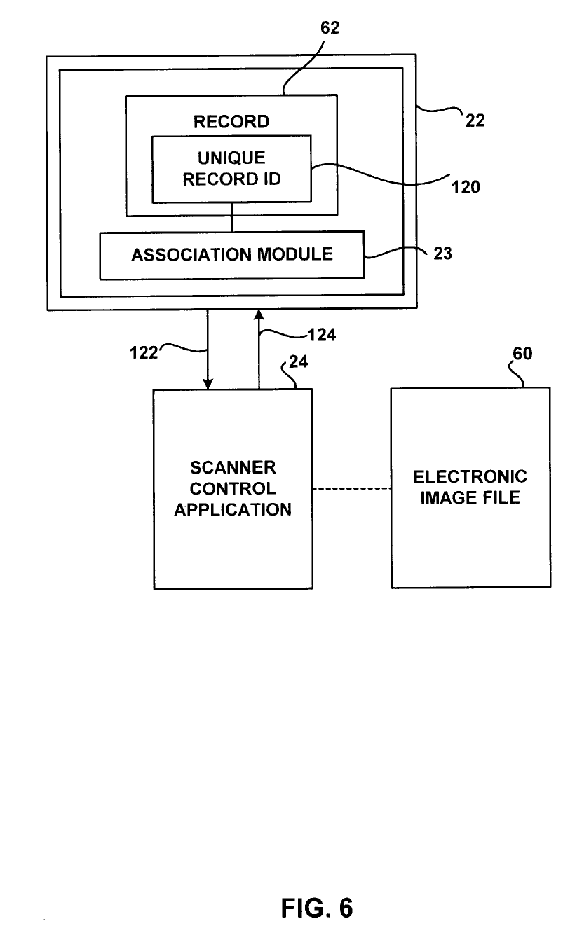

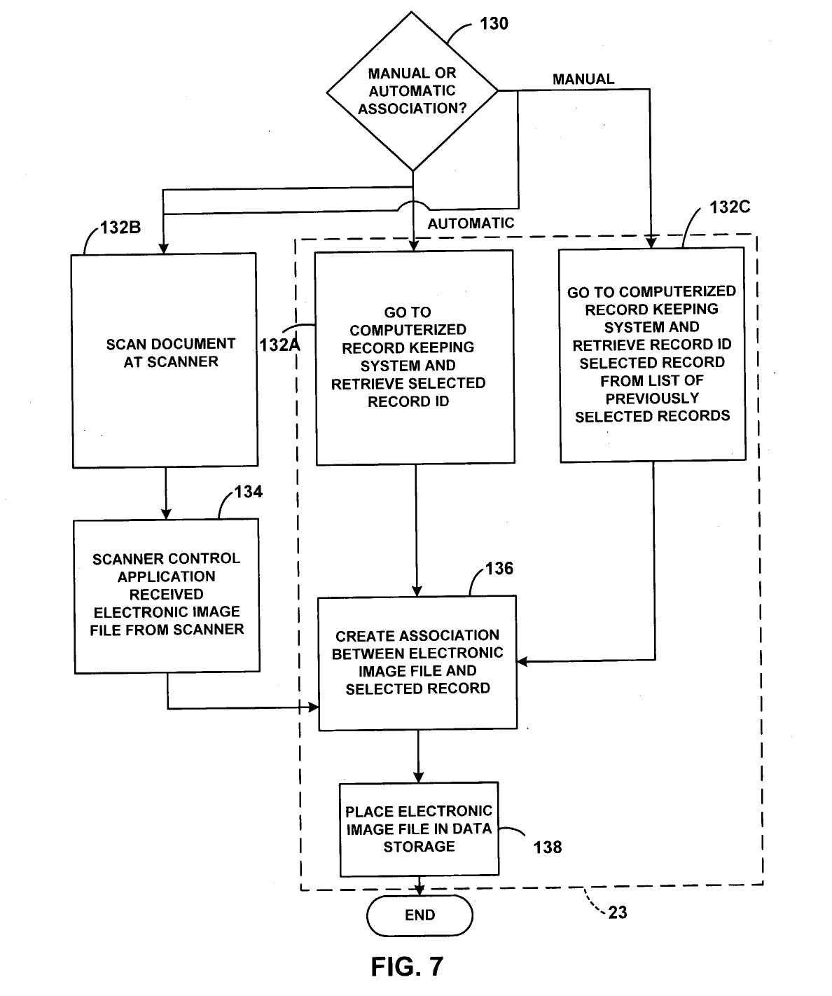

FIGS. 6 and 7 illustrate one alternative embodiment of the present invention. FIG. 6 is a schematic diagram of the alternative embodiment. In FIG. 6, selected record 62 within computerized record keeping system application 22 includes a unique record identifier 120 such as a numeric code. In the example of a patient record, unique record identifier 120 may be a patient's social security number or license number. Unique record identifier 120 is captured by association module 23 and provided to scanner control application 24 (as indicated by arrow 122 pointing toward scanner control application 24 in FIG. 2). In one embodiment, unique record identifier 120 is included in a banner for selected record 62 as part of graphical user interface 80 (see FIG. 4). Association module 23 includes an automated routine that copies a portion of the banner that makes up unique record, identifier 120 and saves it to the clipboard thereby “capturing” the unique record identifier. The routine is automated in that it does not require any additional action by a user. As one skilled in the art will appreciate, in other embodiments, other routines that capture data other than banner data may be utilized in the present invention.

Scanner control application 24 creates an associated electronic image file 60 by processing unique record identifier 120 with the electronic image file. In one embodiment, association module 23 provides captured unique record identifier 120 by modifying the appropriate custom fields in a standard batch file used by scanner control application 24 to identify electronic images produced during scanning operations. Specifically, certain custom fields in the standard batch file are populated with data from the clipboard that included the contents of unique record identifier 120. In other embodiments, scanner control application 24 may use identifier 120 to route electronic image file 60 to a specified storage location thereby creating the association. Alternatively, scanner control application 24 may name electronic image file 60 based on the contents of electronic image identifier 120. As one skilled in the art can appreciate, many other possible ways of creating an association between selected record 62 and electronic image file 60 based on unique record identifier 120 are possible and are contemplated within the scope of the present invention. In still another embodiment, a combination of the embodiment discussed above with respect to FIGS. 4 and 5 and the embodiment discussed above with respect to FIGS. 6 and 7 may be utilized. That is, association module 23 may share information between computerized record keeping system 22 and scanner control application 24, i.e., from system 22 to application 24 (as indicated by arrow 122) and vice versa (as indicated by arrow 124).

FIG. 7 is a flowchart illustrating the steps of a method according to the embodiment illustrated in FIG. 6. First, at step 130, it is determined whether an association between selected record 62 and electronic image file 60 shall be automatically created or manually created. Next, if the association is to be automatically created, at step 132A, unique record identifier 120 from selected record 62 is retrieved and transmitted to scanner control application 24. At the same time, at step 132B, a document is scanned at scanner 38. Then, at step 134, scanner control application 24 receives electronic image file 60 from scanner 38. Next, at step 136, scanner control application 24 creates an association between selected record 62 from computerized record keeping system application 22 and electronic image file 60 from scanner 38 using unique record identifier 120. Finally, at step 138, associated electronic image file 60 is stored in data storage 26 of hard disk drive 16 or another location accessible to personal computer 10. Again, electronic image file 60 may be stored directly in a database portion of computerized record keeping system 22 if instructed by association module 23. The steps that are performed by association module 23 are included on dashed box 23.

Alternatively, if it is determined at step 130 that an association is to be manually created, the method proceeds to step 132C. At step 132C, unique record identifier 120 is retrieved from computerized record keeping system application 22 for the record designated as selected record 62 from a list of previously selected records. In this way, a user can manually select which record to associate with electronic image file 60. The remaining steps are as described above—steps 132B, 134, 136, and 138.

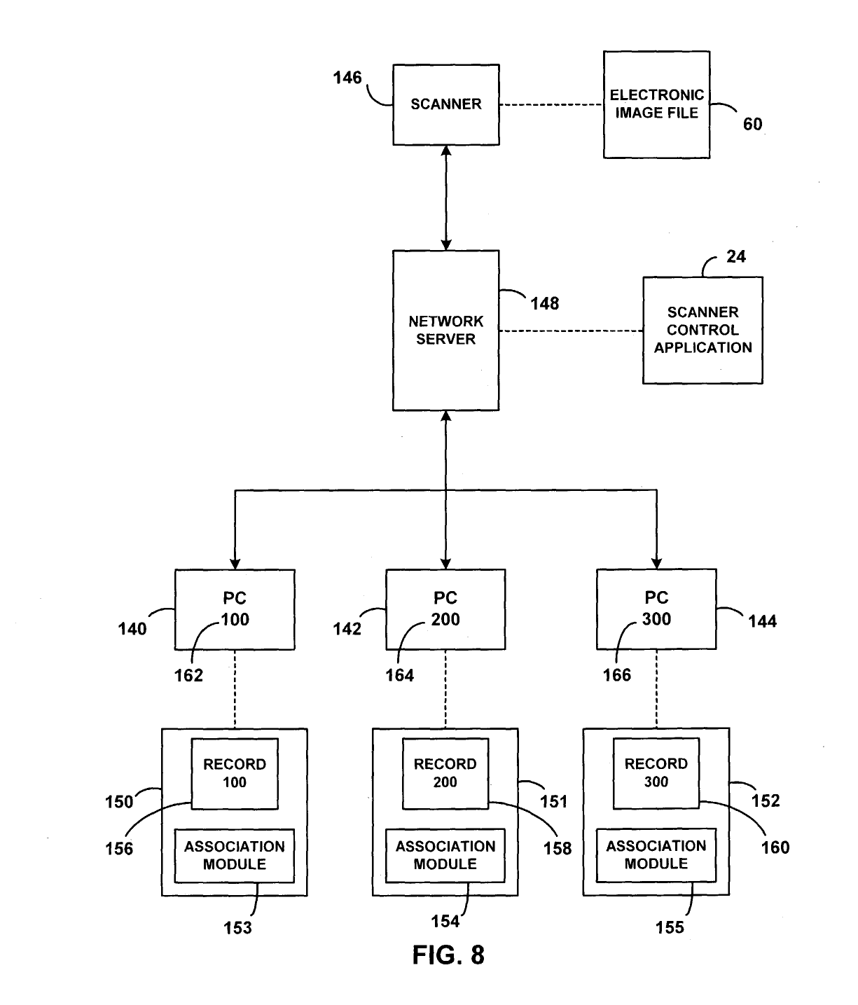

As illustrated in FIG. 8, in another embodiment of the present invention, multiple personal computers 140, 142, 144 share a single scanner device 146 through a network utilizing network server 148. In FIG. 8, scanner control application 24 resides on network server 148. Each of personal computers 140, 142, 144 includes a computerized record keeping system 150, 151, 152, respectively, and each computerized record keeping system includes an association module 153, 154, 155, also respectively. In addition, at any given time, each of computerized record keeping system application 150, 152, 154 may have a selected record 156, 158, 160, respectively. In order to associate electronic image file 60 with the proper selected record from the correct personal computer, each of personal computers 140, 142, 144 includes a computer identifier 162, 164, 166, respectively, (i.e., “100”, “200”, and “300”). Regardless of the manner of association utilized, when a scanning operation is initiated, the respective association module shares the computer identifier with network server 148 and scanner control application 24 to ensure that electronic image file 60 can be associated with the correct selected record on the correct computer.

As one skilled in the art will recognize, there are myriad ways to ensure electronic image file 60 is associated with the correct selected record 62 on the correct computer providing each computer can be individually identified. For example, scanning operations could be initiated directly from computerized record keeping system application 22 directly thereby creating an identifiable roadmap as to which computer initiated the scanning operation. Alternatively, there could be a lock-out feature that essentially allows one to lock out scanner control application 24 when they are getting ready to initiate a scanning operation. This too would provide positive identification as to which computer initiated the scanning operation. More typically, scanning operations will be initiated through scanner control application 24. Accordingly, because the computer identifier will be shared with scanner control application 24, one will be able to determine which personal computer initiates the scanning operation. As a result, electronic image file 60 will be automatically associated with the correct selected record 62 on the correct personal computer.

The present invention allows information related to a currently displayed patient in a registration system (computerized record keeping system) to be automatically shared with or provided to a scanner control application and associated with a scanned image such as an insurance card. Using the present invention, a user does not have to enter the same data twice, i.e., into the registration system and the scanner control application. As a result, this allows the user to perform minimal keystrokes to properly capture and index document images. This also greatly reduces the error rate of improperly indexed documents via incorrect data input. The present invention may also be used to the capturing of a driver's license, an external paper referral, on any other document the user wishes to scan into the system in association with a patient for on-line storage.

The present invention allows all applications running in a computerized record keeping system framework to share patient related information with scanner control application 24. Additionally, the scanner control application is enhanced to easily capture information about the document and patient, process the data and send it to computerized record keeping system 22 where it automatically becomes a document in the imaging system. By using the present invention, the electronic image file is indexed and linked to the appropriate patient and is of the correct document type. Other processes or products do not offer the direct sharing of information between the computerized record keeping system and the scanner control application. Instead, scripting and screen scraping is utilized to mimic true integration.

The communication and sharing of information between a computerized record keeping system and a scanner control application allows an end-user to navigate anywhere within the computerized record keeping system and change patients at will and the scanner control application will always know the patient context. This is done without additional programming customization or maintenance at individual client sites.

One embodiment of the present invention has been disclosed and discussed herein, although it should be understood that the present invention is not limited to this (or any other) particular embodiment. On the contrary, the present invention is intended to cover all alternatives, modifications and equivalents that may be included within the spirit and scope of the appended claims.

What is claimed is:

1. A method of automatically indexing electronic image files generated by a scanner and scanner control application with records in a computerized record keeping system application, comprising the steps of:
selecting a specific record within the computerized record keeping system application;
generating an electronic image file of a document by scanning the document using the scanner controlled by the scanner control application; and
automatically associating said electronic image file with said selected record using an automated routine that requires no action by a user.

2. A method as in claim 1, further comprising the step of providing each of the electronic image files with a unique filename and a specific storage location.

3. A method as in claim 2, wherein said associating step includes adding said unique filename and said specific storage location to said selected record.

4. A method as in claim 1, further comprising the step of providing said selected record with a unique record identifier.

5. A method as in claim 4, wherein said associating step includes sharing said unique record identifier with the scanner control application.

6. A method as in claim 4, wherein said associating step includes creating an association between said selected record and said electronic image file by manually selecting record identifier information from a list of previously selected records.

7. A method as in claim 1, further comprising the step of controlling the scanner control application with the computerized record keeping system application.

8. A method as in claim 1, further comprising the step of providing a means for creating an association between said selected record and said electronic image file.

9. A method of automatically indexing scanned electronic image files related to patients, comprising the steps of:
providing a computerized record keeping system application that includes at least one electronic patient record;
specifying a selected electronic patient record from said at least one electronic patient record within said computerized record keeping system application;
providing a scanner and a scanner control application for controlling said scanner;
placing said scanner control application in communication with said computerized record keeping system application;
scanning a document using said scanner controlled by said scanner control application thereby creating an electronic image file of the document;
providing an association module that includes an automated routine for automatically associating said selected electronic patient record with said electronic image file, said automated routine requiring no action by a user; and
automatically associating said electronic image file of the document with said selected electronic patient record that was selected at the same time said scanning step was initiated according to said instructions in said association module.

10. A method as in claim 9, further comprising the step of providing each of the electronic image files with a unique filename and a specific storage location.

11. A method as in claim 10, wherein said associating step includes adding said unique filename and said specific storage location to said electronic patient selected record.

12. A method as in claim 9, further comprising the step of providing said selected electronic patient record with a unique record identifier.

13. A method as in claim 12, wherein said automated routine includes sharing said unique record identifier with said scanner control application.

14. A method as in claim 9, wherein said associating step includes creating an association between said selected record and said electronic image file by manually selecting record identifier information from a list of previously selected records.

15. A method as in claim 9, further comprising the step of controlling said scanner control application with the computerized record keeping system application.

16. A method as in claim 9, further comprising the step of providing a means for creating an association between said selected record and said electronic image file.

17. A system for automatically sharing data between a scanner control application used for controlling a scanner during the generation of electronic image files and a computerized record keeping system application used for creating and maintaining records, the system comprising:
a module adapted to designate a selected record by selecting a specific record within the computerized record keeping system application;
a module adapted to generate an electronic image file of a document by scanning the document using the scanner controlled by the scanner control application; and
an association module adapted to automatically associate said electronic image file with said selected record using an automated routine that requires no action by a user.

18. A system according to claim 17, wherein said association module includes creating an association between said selected record and said presently generated electronic image file by manually selecting identifier information from a list of previously selected records.

19. A system according to claim 17, further comprising a module adapted to control the scanner control application with the computerized record keeping system application.

20. A system according to claim 17, wherein said association module includes a means for manually creating an association between said selected record and said electronic image file.

21. A method of automatically indexing electronic image files generated by a scanner and scanner control application with records in a plurality of computerized record keeping system applications stored on a plurality of computing devices, comprising the steps of:
designating a selected record by selecting a specific record within a specific computerized record keeping system application from the plurality of computerized record keeping system applications;
generating an electronic image file of a document by scanning the document using the scanner controlled by the scanner control application; and
automatically associating said electronic image file with said selected record using an automated routine that requires no action by a user.

22. A method as in claim 21, further comprising the step of providing each of the computing devices with a unique computing device identifier.

23. A method as in claim 22, further comprising the step of providing each of the electronic image files with a unique filename and a specific storage location.

24. A method as in claim 23, wherein said associating step includes adding said unique filename and said specific storage location to said selected record on the computerized record keeping system located on the computing device that matches said unique computing device identifier.

25. A method as in claim 21, further comprising the step of providing said selected record with a unique record identifier.

26. A method as in claim 25, wherein within said associating step, said electronic image file and said selected record are associated according to said unique record identifier.

27. A method as in claim 21, wherein said associating step includes creating an association between said selected record and said electronic image file by manually selecting record identifier information from a list of previously selected records.

28. A method as in claim 21, further comprising the step of controlling the scanner control application with the computerized record keeping system application.

29. A method as in claim 21, further comprising the step of providing a means for creating an association between said selected record and said electronic image file.
